(19) United States
(12) Patent Application Publication
(10) Pub. No.: US 2005/0181099 A1
(43) Pub. Date: Aug. 18, 2005

(54) Process for producing nugget food

(76) Inventors: Yuko Tazuke, Kobe-Shi (JP); Hideaki Yokoyama, Kobe-Shi (JP)

Correspondence Address: J C PATENTS, INC., 4 VENTURE, SUITE 250, IRVINE, CA, 92618, US

(21) Appl. No.: 11/107,079

(22) Filed: Apr. 15, 2005

Related U.S. Application Data
(63) Continuation of application No. PCT/JP03/13356, filed on Oct. 17, 2003.

(30) Foreign Application Priority Data
Oct. 18, 2002 (JP) 2002-303811

(51) Int. Cl. A23G 3/00

(52) U.S. Cl. 426/94

(57) ABSTRACT

It is intended to produce a nugget food product having a soft and smooth texture. The process for producing a nugget food product includes preparing a dough by blending 5 to 50% of tofu with 0.5 to 20% of a fat, molding the dough, steaming, battering, frying and freezing. The tofu in the dough includes a freeze-resistant tofu. Alternatively, in the case of using tofu having no freeze resistance, α-starch is added to the dough.

### CROSS-REFERENCE TO RELATED APPLICATION

This application is a continuation-in-part of a prior PCT application Ser. No. PCT/JP2003/13356, filed on Oct. 17, 2003, which claims the priority benefit of Japanese application serial no. 2002-303811, filed on Oct. 18, 2002. All disclosure of this application is incorporated herein by reference.

### BACKGROUND OF THE INVENTION

1. Field of the Invention

The present invention relates to a process for producing a nugget food.

2. Description of the Related Art

The commodities of processed chicken meat widely distributed in the market include barbecued chicken, fried chicken, sauce-broiled chicken and chicken nuggets. As described in the new version of the Comprehensive Dictionary of Food Industry, which is edited by Japanese Society of Food Science and Technology, a chicken nugget is a small piece of chicken meat that is flavored and fried, containing mostly the breast meat without skin and having a portion of thigh meat or white meat. In general, a chicken nugget is a type of food produced by battering a piece of chicken meat and then frying it, as described in Japanese Patent Application Laid Open No. Hei 3-151855 and Hei 11-103826. Recently, the consumers prefer the foods with soft textures. However, since the conventional chicken nuggets mainly include lean meat, they mostly have dry textures even though having the taste and chewiness of the meat.

To improve the texture, a soybean protein emulsion has been used as a binding material of the nugget food products, as described in Japanese Patent Application Laid Open No. Sho 62-25952. However, none of the prior methods utilizes tofu to improve the texture.

In recent years, tofu has received much attention as a highly healthy food. Though some foods with the combination of tofu and chicken meat, such as the tofu hamburger, are known in the prior art, the soft texture is usually degraded by certain factors including the denaturation of the tofu due to freezing. Ultimately, the foods still have dry and coarse textures.

### SUMMARY OF THE INVENTION

The degradation of soft texture is also one problem of the tofu-added chicken nuggets, for the combination of only chicken meat and tofu makes the food have a dry and coarse texture without the inherent smoothness and softness of the tofu. Accordingly, this invention provides a process for producing a nugget food product that has a smooth and soft texture.

In this invention, it is discovered that by adding tofu and a fat into the dough, a nugget food product as tender and smooth as tofu can be produced.

Specifically, this invention provides a process for producing a nugget food product, which includes preparing a dough by blending a binding material and an ingredient material, molding the dough, steaming, battering, frying and freezing, wherein the dough is added with tofu and a fat. It is preferred to use freeze-resistant tofu. Alternatively, in the case of using tofu having no freeze resistance, an α-starch is added to the dough. The amount of the tofu in the dough is preferably 5-50 wt %, and that of the fat is preferably 0.5-20 wt %. Furthermore, when the binding material includes an emulsion of soybean protein, fat and water, the total amount of the fat in the emulsion and the fat added subsequently is preferably more than 1.5 times the amount of the soybean protein.

By adding into the dough a fat and tofu, especially a freeze-resistant tofu, or a combination of a fat, a paste-like chilled tofu and an α-starch, a tofu-added nugget food product having a very tender and smooth texture after freezing and re-frying can be obtained.

It is to be understood that both the foregoing general description and the following detailed description are exemplary, and are intended to provide further explanation of the invention as claimed.

### DESCRIPTION OF THE PREFERRED EMBODIMENTS

This invention features tofu and a fat being added to the dough in a process for producing a nugget food product, which includes preparing a dough by blending a binding material and an ingredient material, molding the dough, steaming, battering, frying and freezing.

In this invention, the binding material can be any material known in the art, such as, a soybean protein emulsion obtained by kneading a soybean protein powder, fat and water, or one obtained from the ground meat of bird, animal, fish or shellfish. The species of the bird, animal, fish or shellfish meat are not particularly restricted, but the chicken meat having less fat and easily having a dry texture is particularly preferred for showing the effect of this invention. The ingredient material may be obtained by mixing granular soybean protein or flavors, vegetable and bread crumbs, etc. The binding material can be prepared by using a blender like a silent cutter, and is then mixed with the ingredient material to form the dough. The weight ratio of the binding material to the ingredient material preferably ranges from 20:80 to 80:20.

After the dough is prepared, a nugget food product can be produced with the steps including molding the dough, steaming the dough, battering, frying and freezing, wherein each process can be one known in the art. The molding process can utilize any prior method like drum molding or extrusion molding to mold the dough in a mouthful size or in a maximal diameter of several centimeters. The steaming process may utilize water vapor steaming at 80-95° C. for 5-20 minutes to simultaneously solidify and sterilize the dough with heat. The batter material is not particularly restricted; the commercially available batter mixing powder specifically for a nugget food product can be used. The frying process is conducted at 130-190° C. for 10 seconds to 5 minutes, preferably 30 sec to 2 min. After the frying process, the nugget food product is frozen, preferably rapidly frozen, so that the nugget food product can have a smooth and soft texture.

Moreover, the frozen nugget food is required to be re-heated before eating, and is preferably be re-fried, directly in a frozen state or in a defrosted state, at 160-170° C. for 4-5 minutes. Alternatively, a microwave oven is used instead of the re-frying treatment to heat the nugget food before eating.

Accordingly, the first feature of this invention is that a tofu, which is not applied to the conventional chicken nuggets, is added to the dough. Thereby, the dough can have the soft texture of the tofu.

The tofu used in this invention can be one generally known in the prior art. In a typical tofu production, soybean is immersed in water for certain time and then ground. The ground soybean is added with water and then heated. A soybean milk is obtained after being separated from the soybean curd refuse. A coagulant is further added to the soybean milk to produce a tofu. Moreover, since the smooth texture will be degraded if a sponge-like or laminar structure is formed in the frozen tofu as in the case of a freeze-dried tofu (e.g., Koya tofu), the tofu with freeze resistance is preferred. When a freeze-resistant tofu is being frozen, a sponge-like or laminar structure as found in the freeze-dried tofu is not formed, so that the normal texture of the tofu can be maintained. The method for giving freeze resistance to tofu can be any method known in the art, and is not particularly restricted. For example, oligosaccharides like trehalose and oligose, sugar alcohol, starch materials like raw starch and chemically-modified starch, etc., enzymes like transglutaminase, etc., and gelatinizers/thickeners like native gellan gum, curdlan, casein, agar, carrageenan, furcellaran, alginate salt, xanthan gum, tamarind gum, locust bean gum, Arabia gum, guar gum, pectin, konjak mannan and gelatin can be added, singly or in combination, to produce the freeze resistance. More specifically, for example, it is feasible to add into a soybean milk of low viscosity having a solid content exceeding 10% one or more freeze-resisting agents selected from saccharides, starches and transglutaminase, and a coagulant, as described in PCT Patent Publication No. WO 00/21389. It is also feasible to add native gellan gum and a chemically-modified starch material and then a coagulant to produce freeze resistance, as described in Japanese Patent Application Laid Open No. 2003-225064. The commercially available freeze-resistant tofu products may also be used.

The freeze-resistant tofu may be added into the binding material, or alternatively into the ingredient material if only the shape of the dough can be maintained.

On the other hand, ordinary tofu without freeze resistance, i.e., chilled tofu, may alternatively be used, but is preferably added into the binding material in combination with an α-starch that is different from the starch added as a freeze-denaturation inhibitor of the whole dough. The raw starches represented by corn starch and potato starch, etc. have poor dispersibility, so that a portion of the tofu will be freeze-denaturated when the nugget is being frozen and the target quality cannot be obtained. Moreover, when the dough is prepared at a low temperature, the texture after freezing will be deteriorated if the ingredients in the dough are dispersed unevenly. In such a case, an α-starch is preferably added for having a good dispersibility in cold water. Usually, the dispersibility in cold water is produced by subjecting the α-starch to a granulation treatment, but any other type of α-starch can still be used if only the same degree of dispersibility in cold water is shown. The amount of the α-starch added into the dough is preferably 0.1-5 wt %. When the amount of the α-starch is less than 0.1 wt %, the freeze resistance is insufficient. When the amount of the α-starch is more than 5 wt %, the texture tends to be unnatural and the taste is also degraded. Examples of the α-starch having a good dispersibility in cold water include Ultra sperse M and Ultra sperse 5 that are produced by National Starch and Chemical Company of Japan.

Moreover, the type of the tofu used may be cotton-strained tofu, tender tofu or silk-strained tofu, etc., wherein the water-rich tofu products like silk-strained tofu is preferred. The amount of the tofu in the dough is usually 5-50 wt %, preferably 10-45 wt % and more preferably 20-40 wt %. If the amount of the added tofu is less than 5 wt %, a tender texture cannot be obtained. If the amount exceeds 50 wt %, the dough is too soft to mold with the molder.

The second feature of this invention is that a fat is added to the dough. By doing so, the dough becomes juicy through re-heating before eating. Therefore, the whole nugget food product can be provided with a soft and smooth texture due to the fat.

The fat added may include one or more fats selected from animal fats like lard, tallow and fish oil, etc., and hardened fats thereof; vegetable fats like palm oil, shea fat, sal fat, illipe fat and cocoa fat, etc., and hardened fats and fractional fats thereof; and liquid vegetable fats obtained from oil seeds like rapeseed, soybean, sunflower seed, safflower seed, corn and peanut, etc., and hardened oils and fractional oils thereof. Among the above fats, the lard and the rapeseed oil are preferred in consideration of the taste of the nugget food product.

If the fat used is a solid fat at a room temperature of 15-25° C., it can be easily mixed uniformly with an emulsion of a soybean protein powder, water and fat, or with a binding material obtained from ground meat of bird, animal, fish or shellfish. In such cases, a dough without exudation of the fat on its surface can be easily obtained even if relatively excess amount of the fat has been added. Therefore, by adding a larger amount of a solid fat into the dough, it is possible to make the nugget food have a smooth texture after freezing and re-heating. However, when the product is consumed cold, the solidness of the solid fat is sensed. Accordingly, the product tends to have a coarse texture. On the contrary, when the fat added is a liquid fat, it is difficult to uniformly emulsify with the emulsion of the soybean protein powder, water and fat, or with a binding material obtained from bird, animal, fish or shellfish meat. However, the texture of the product can be easily maintained through the steaming process conducted after the difficult addition process and before the frying process, so that the product can have a smooth texture after being heated for eating. Meanwhile, the product will not have the coarse texture caused by solid fat even if the product is consumed cold.

As for the method of adding the fat, the fat is preferably added into a binding material well known in the prior art, such as, a soybean protein emulsion produced by kneading a soybean protein powder, fat and water or a binding material obtained from ground meat of bird, animal, fish or shellfish, after the binding material is produced, but may alternatively be added as the soybean protein emulsion is being prepared or as the meat of bird, animal, fish or shellfish is being ground. However, if the fat is added when the binding material is being prepared, the workability is poor due to difficult hydration of the soybean protein, and the effect of providing a tender and smooth texture to the food is worse as compared with the case where the fat is added after the binding material is prepared. Moreover, in a pilot-scale production of the nugget food products, the fat is usually mixed with the binding material using a silent cutter of 1400 rpm that is possibly produced by Yanagiya Machinery Co., Ltd. and can make high-speed rotation. However, in a real-scale production, a closed ball cutter of 3000 rpm possibly manufactured by Yanagiya Machinery Co., Ltd. is preferred. In this invention, the amount of the added fat may exceed the amount required for retaining a good emulsion state of the binding material. For example, when a soybean emulsion is used and the required amount of the fat is 1.5 times the solid content of the soybean protein, the total amount of the added fat and the fat originally in the soybean protein emulsion may be more than 1.5 times the amount of the soybean protein in this invention. In the cases where the fat is added after the binding material is prepared, the amount of the fat excluding the fat originally in the binding material may be 0.5-20%, preferably 3-20%, in the whole dough. If the amount is less than 0.5%, the smooth texture cannot be obtained. If the amount exceeds 20%, much fat will exude to the surface of the dough even with the steaming treatment. As a result, the batter layer easily peels off.

This invention will be further explained with the following examples, but which are not intended to restrict the scope of this invention. In these examples, “%” and “part” mean “wt %” and “weight part”, respectively.

### EXAMPLE 1

### Preparation of Nugget Food Products

According to the composition list in Table 1, a soybean protein powder, a fat and water is kneaded using a silent cutter, and the mixture is added with chicken, common salt and lard and then emulsified to a binding material. Next, a starch (Colflo 67 from National Starch and Chemical Company of Japan) and egg white are added, followed by adding a frozen tofu (Tofreeze S from Fuji Oil Co., Ltd.). The mixture is then cut using a cutter to obtain a binding material. The ingredient material is obtained by mixing, with a kneader, granular soybean proteins, flavors, egg white and dextrin (Sundeck 250 from Sanwa Cornstarch Co., Ltd.), and is further blended with the binding material having been subjected to the cutting. After that, the mixture is blended with vegetables like onion, green soybean and carrot, Jew's-ear and bread crumbs to prepare a dough.

TABLE 1
Composition list of the dough

| | Component | Added amount (part) |
|---|---|---|
| Binding material | soybean protein powder | 2.5 |
| | fat (rapeseed oil) | 2.5 |
| | water | 13 |
| | chicken (breast meat) | 12 |
| | common salt | 0.3 |
| | lard | 5.3 |
| | starch | 0.2 |
| | dried egg white | 0.5 |
| | frozen tofu | 32 |
| Ingredient material | granular soybean protein | 0.7 |
| | flavors | 2 |
| | egg white | 2 |
| | dextrin | 0.3 |
| | onion | 8 |
| | green soybean | 8 |
| | carrot | 5.7 |
| | Jew's-ear | 4 |
| | bread crumb | 1 |
| | Total | 100.0 |

The dough is then molded into round pieces with each weighing 14 g, and the round pieces are steamed at 90° C. for 10 minutes. Each round piece of dough is battered, fried at 155° C. for 40 seconds, and then frozen at −35° C. The batter material may be the commercially available batter mix powder used for nugget food.

### COMPARATIVE EXAMPLE 1

The added amount of the frozen tofu (Tofreeze S from Fuji Oil Co., Ltd.) is changed from 32 parts to 0, 3.6 parts, 17 parts, 45 parts, 68 parts and 160 parts, respectively, while the other steps are the same as those of Example 1 for producing the nugget food products.

To evaluate the quality of the nugget food products from Example 1 and Comparative Example 1, the frozen nuggets are re-fried at 160-170° C. for 4-5 minutes and then evaluated in texture by 5 skilled panelists. The evaluation results are represented by the following symbols.

Evaluation in Soft Texture
\mathring{∘}: very soft
◯: soft
Δ: slightly tough
×: very tough

Evaluation in Smooth Texture
\mathring{∘}: very smooth
◯: smooth
Δ: slightly coarse

×: very coarse

TABLE 2
Evaluation Results

| | Example 1 | Comparative Example 1 | | | | | |
|---|---|---|---|---|---|---|---|
| tofu (part) | 32 | 0 | 3.6 | 17 | 45 | 68 | 160 |
| Softness | ⊚ | X | ◯ | ⊚ | ⊚ | ◯ | — |
| Smoothness | ⊚ | X | ◯ | ⊚ | ⊚ | ◯ | — |

As indicated by Table 2, the cases wherein the dough containing an amount of 3.6-68 parts (5-50%) of the tofu is preferred, while the chicken nuggets produced from the dough with a tofu amount of 17-45 parts (20-40%) have textures most like that of silk-strained tofu, and the very tender and smooth texture of the dough well matches the crispy texture of the batter layer. The chicken nugget without the addition of tofu results in no soft or smooth texture. In addition, the dough containing 160 parts of tofu cannot be molded using the molder.

### EXAMPLE 2

The nugget food products are prepared as in Example 1, except that the amount of the lard is changed from 5.3 parts to 0.5 part, 1 part, 3 parts, 17 parts, 23 parts and 65 parts, respectively. The nuggets are evaluated for whether the batter layer peels off or not as well as for the smooth texture. The evaluation results are represented by the following symbols:
◯: batter layer does not peel off

×: batter layer peels off

TABLE 3

| | Amount (part) of lard | | | | | | |
|---|---|---|---|---|---|---|---|
| | 0.5 | 1 | 3 | 5.3 | 17 | 23 | 65 |
| Condition of batter | ◯ | ◯ | ◯ | ◯ | ◯ | ◯ | X |
| layer | | | | | | | |
| Smooth texture | X | Δ | ⊚ | ⊚ | ⊚ | ⊚ | ⊚ |

As indicated by Table 3, when the amount of the lard is 0.5-23 parts (0.5-20% in the dough), the batter layer will not peel off from the dough core; when the amount of the lard is 3-23 parts (3-20% in the dough), the nugget has a very smooth texture. Therefore, the range of 3-23 parts for the lard is more preferred. In addition, when the amount is 0.5 part, a smooth texture due to the lard is not apparent; when the amount is 65 parts, the batter layer easily peels off due to the lard exuding to the surface of the dough in the steaming step.

### EXAMPLE 3

The nugget food products are prepared as in Example 2, except that the lard is completely replaced with rapeseed oil. The nuggets are evaluated in the same manner.

TABLE 4

| | Amount (part) of rapeseed | | | | | | |
|---|---|---|---|---|---|---|---|
| | oil in replacement of lard | | | | | | |
| | 0.5 | 1 | 3 | 5.3 | 17 | 23 | 65 |
| Condition of batter layer | ◯ | ◯ | ◯ | ◯ | ◯ | ◯ | X |
| Smooth texture | X | Δ | ⊚ | ⊚ | ⊚ | ⊚ | ⊚ |

As indicated by Table 4, when the lard is replaced with the rapeseed oil, the conditions of the batter layers and the smooth texture are still the same.

Moreover, in a test where the frozen products are re-fried at 160-170° C. for 4-5 minutes and then consumed after 3 hours, the product having 5.3 parts of lard in Example 2 has a coarse texture, while the product having 5.3 parts of rapeseed oil in Example 3 does not have a coarse texture but still has a smooth texture.

Moreover, the case using 5.3 parts of rapeseed oil instead of the lard in Table 4, i.e., the case where extra rapeseed oil in an amount of 5.3 parts is added after a soybean protein emulsion containing 2.5 parts of rapeseed oil is prepared, is compared with the case where the rapeseed oil replacing the lard is added when the soybean protein emulsion is being prepared, i.e., the case where 2.5 parts of soybean protein powder, 7.8 parts of rapeseed oil and 13 parts of water are kneaded using a silent cutter to prepare an emulsion without any rapeseed oil added after the emulsion is prepared. It is discovered that in the former case, the product has to be subjected to long-time hydration due to the difficulty in mixing the soybean protein and water, and the smoothness thereof is worse than that in the latter case where the rapeseed oil is added separately. Nevertheless, the product of the former case has a smoother texture as compared with the product of the case where one part of rapeseed oil is added to replace the lard as shown in Table 4.

Furthermore, for the case where 5.3 parts of rapeseed oil is added instead of the lard as shown in Table 4, the batter layer still does not peel off from the inner dough when the nugget food product is prepared as above only without the steaming. Therefore, nuggets of good quality can still be obtained without the steaming.

### EXAMPLE 4

The nugget food products are prepared as in Example 1, except that the freeze-resistant frozen tofu is replaced with a commercially available chilled tofu without freeze resistance and an α-starch (Ultra sperse 5 from National Starch and Chemical Company of Japan) is added in an amount of 0.3 part.

### COMPARATIVE EXAMPLE 2

The nugget food products are prepared as in Example 1, except that the freeze-resistant frozen tofu added to the binding material is replaced with a commercially available chilled tofu without freeze resistance that is added to the ingredient material without being cut in a cutter, and optionally an α-starch (Ultra sperse 5 from National Starch and Chemical Company) is added in an amount of 0.3 part. The evaluated aspects include the softness and the smoothness in the texture and whether freeze denaturation occurs or not.

In the evaluation of whether freeze denaturation occurs or not, the symbol “◯” represents that no freeze denaturation occurs, “Δ” represents that freeze denaturation occurs slightly, and “×” represents that freeze denaturation occurs severely.

TABLE 5

| | Example 3 | Comparative Example 2 | | |
|---|---|---|---|---|
| Cutting tofu? | Yes | No | Yes | No |
| Adding α-starch? | Yes | Yes | No | No |
| Soft texture | ⊚ | ◯ | ◯ | X |
| Smooth texture | ⊚ | Δ | X | X |
| Freeze denaturation | ◯ | X | X | X |

When the tofu is added into the binding material without being cut previously, the nugget food products have quite tender textures due to the soft texture from the tofu. However, when the tofu is added into the ingredient material, the tofu appears to be granular so that an unpalatable sense of unevenness is resulted and the freeze denaturation occurs throughout the nuggets. That is, though the soft texture is present in the nuggets, the nuggets still have coarse textures.

Moreover, when the α-starch is not added to the dough, the freeze denaturation still occurs even if the tofu is cut into a paste, so that the same texture of the silk-strained tofu cannot be produced.

Utility in the Industry

In the prior art, a tofu-added nugget food product cannot have a smooth and soft texture after being frozen or defrosted and then re-fried. However, by utilizing this invention, a tofu-added nugget food product that has a very tender and smooth texture even after being frozen or defrosted and then re-fried can be obtained. Therefore, this invention is suitably applied to the tofu-added nugget food products that can be distributed in frozen conditions, for example.

It will be apparent to those skilled in the art that various modifications and variations can be made to the structure of the present invention without departing from the scope or spirit of the invention. In view of the foregoing, it is intended that the present invention covers modifications and variations of this invention provided they fall within the scope of the following claims and their equivalents.

1. A process for producing a nugget food product, comprising preparing a dough from a binding material and an ingredient material, molding the dough, steaming, battering, frying and freezing, wherein the dough is added with a tofu and a first fat.

2. The process of claim 1, wherein the tofu comprises a freeze-resistant tofu, or wherein the tofu comprises a tofu without freeze resistance and is added together with an α-starch.

3. The process of claim 1, wherein an amount of the tofu in the dough is 5-50 wt %.

4. The process of claim 1, wherein an amount of the fat in the dough is 0.5-20 wt %.

5. The process of claim 1, wherein when the binding material comprises an emulsion of a soybean protein, a second fat and water, a total amount of the first fat and the second fat is more than 1.5 times an amount of the soybean protein.
